(19) United States
(12) Patent Application Publication
(10) Pub. No.: US 2012/0133786 A1
(43) Pub. Date: May 31, 2012

(54) IMAGE PROCESSING METHOD AND IMAGE PROCESSING DEVICE

(75) Inventors: Yuri WATANABE, Machida (JP); Kimitaka Murashita, Kawasaki (JP)

(73) Assignee: FUJITSU LIMITED, Kawasaki (JP)

(21) Appl. No.: 13/367,707

(22) Filed: Feb. 7, 2012

Related U.S. Application Data
(63) Continuation of application No. PCT/JP2009/003930, filed on Aug. 18, 2009.

(51) Int. Cl. H04N 5/262

(52) U.S. Cl. 348/208.4; 348/E05.051

(57) ABSTRACT

An image processing method generates a combined image from first and second images of a plurality of images obtained through continuous shooting. The method includes: detecting a noise level in accordance with the first and second images; calculating a shift amount for making the noise level small; generating a transformed image by shifting coordinates of each pixel of the second image in accordance with the shift amount; and combining the first image and the transformed image to generate the combined image.

### CROSS-REFERENCE TO RELATED APPLICATION

This application is a continuation of an international application PCT/JP2009/003930, which was filed on Aug. 18, 2009.

### FIELD

The embodiments described herein are related to a method and device for processing digital images, and it can be applied to, for example, a method for correcting a camera shake of an electronic camera by utilizing a plurality of images.

### BACKGROUND

In recent years, electronic cameras provided with a camera-shake correction function have been put into practical use. Camera-shake correction is achieved using an optical technology or an image processing. The extent of the camera shake may be decreased by shortening the exposure time. However, if the exposure time becomes short, the amount of light decreases, and this will increase noise in the image. Accordingly, camera shake correction by image processing is achieved by shortening the exposure time for each shot and by aligning and then combining, for example, a plurality of images obtained via continuous shooting.

A camera shake occurs if a camera moves while an image is being shot. Here, the movement of a camera is defined by six elements, illustrated in FIG. 1.
(1) YAW
(2) PITCH
(3) Right-left translation (Horizontal)
(4) Up-down translation (Vertical)
(5) ROLL
(6) Front-back translation (Perspective)

However, when a camera is shaken in the YAW direction, the image is displaced approximately in the horizontal direction. When the camera is shaken in the PITCH direction, the image is displaced approximately in the vertical direction. Therefore, the relationship between the movement element of the camera and the displacement component is as illustrated in FIG.

2.

As an example, in a camera-shake correction, a shake amount is detected between two images obtained via continuous shooting (i.e., a first image and a second image), and the second image is transformed (e.g., the affine transformation) to compensate for the shake amount. That is, alignment is performed. The first image and the transformed second image are then combined, thereby obtaining an image to which camera correction has been applied.

In the affine transformation, the coordinates of each pixel of an original image are transformed in accordance with the following formula (1).

$$( \begin{matrix}{x}^{′} \\ {y}^{′} \\ 1\end{matrix} ) = ( \begin{matrix}S cos θ & - S sin θ & dx \\ S sin θ & S cos θ & dy \\ 0 & 0 & 1\end{matrix} ) ( \begin{matrix}x \\ y \\ 1\end{matrix} ) \qquad ( 1 )$$

In this formula, “dx” indicates the amount of horizontal displacement, and “dy” indicates the amount of vertical displacement. “θ” indicates the rotation angle of the displacement of the camera in the ROLL direction. “S” indicates the enlargement/reduction rate provided by the movement of the camera in the perspective direction. (x, y) indicates the coordinates of the image before the transformation. (x′, y′) indicates the coordinates of the transformed image. FIG. 3 illustrates an example of an image transformation by the affine transformation. In the example illustrated in FIG. 3, the image is translated and rotated clockwise via the affine transformation.

In the affine transformation, however, a pixel in an image after transformation is not obtained from one pixel in an image before transformation. That is, each pixel of the image after transformation is typically represented by a plurality of pixels of the image before transformation. In the example in FIG. 4, pixel E of the image after transformation is represented by four pixels A to D of the image before transformation.

Here, the pixel value of one of the pixels A to D (e.g., the pixel C) may be used as the pixel value of the pixel E after transformation. In this way, however, a jaggy could be seen on the contour of the image.

To solve this problem, for example, a method is known in which interpolation is performed using the pixel values of neighboring pixels. When an image after transformation is restored by linearly interpolating pixel values, a pixel value P of the pixel E is calculated in the following formula.

P 32 Sa×Pa+Sb×Pb+Sc×Pc+Sd×Pd

Pa to Pd indicate the pixel values of the pixels A to D, respectively. Sa to Sd indicate the areas of the portions of the pixel E occupied by the pixels A to D, respectively.

The following image processing device has been proposed as a related art. That is, multiple resolution images of a reference image and a comparison image are created. To the images of low resolution, whole range matching is applied to detect a two-dimensional displacement between the images. To the images of comparatively high resolution, a displacement in each block is detected by block matching. By correcting the movement data by the higher-resolution image by use of the movement data found in the preceding stage as an initial value sequentially from minimum resolution to higher resolution, accuracy of the image is improved. (Japanese Laid-open Patent Publication No. 2007-226643, for example)

Image processing methods described in Japanese Laid-open Patent Publication No. 2000-298300, Japanese Laid-open Patent Publication No. 2004-234623, and Japanese Laid-open Patent Publication No. 2001-223932 have also been proposed as other related arts.

In the affine transformation, however, a complex matrix operation needs to be carried out on all pixels to correct a positional displacement caused by rotation or enlargement/reduction. That is, the calculation amount of the affine transformation is large. Also in the affine transformation, when the pixel value of a pixel of a transformed image is interpolated using the pixel values of their neighboring pixels, the image could be blurred. In this case, the quality of the combined image will also be degraded.

### SUMMARY

According to an aspect of an invention, an image processing method for generating a combined image from first and second images of a plurality of images obtained through continuous shooting, the method includes: detecting a noise level in accordance with the first and second images; calculating a shift amount for making the noise level small; generating a transformed image by shifting coordinates of each pixel of the second image in accordance with the shift amount; and combining the first image and the transformed image to generate the combined image.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory view of the movement elements of a camera.

FIG. 2 is a table indicating the relationship between the movement elements of a camera and the displacement components of the image.

FIG. 3 illustrates an example of an image transformation by the affine transformation.

FIG. 4 is a diagram illustrating linear interpolation of a pixel value.

FIG. 5 is a flowchart illustrating an example of a camera shake correction process.

FIG. 6 is a diagram illustrating a configuration of an image processing device in accordance with a first embodiment.

FIGS. 7A-7D illustrate an outline of an image combining method in accordance with the first embodiment.

FIG. 8 is a flowchart illustrating a procedure for calculating a shift amount in the first embodiment.

FIG. 9 is a diagram illustrating a configuration of an image processing device in accordance with a second embodiment.

FIG. 10A is a diagram illustrating a method for extracting a noise component of a combined image.

FIG. 10B illustrates an example of a smoothing filter.

FIG. 11 is a flowchart illustrating a procedure for calculating a shift amount in the second embodiment.

FIG. 12 and FIG. 13 are flowcharts illustrating a procedure for calculating a shift amount by using the first and second embodiments.

FIG. 14 and FIG. 15 are flowcharts illustrating an image processing method in accordance with other embodiments.

FIG. 16 is a diagram illustrating the selection range of a shift amount which depends on a rotational component.

FIG. 17 is a flowchart illustrating an image processing method in accordance with yet another embodiment.

FIGS. 18A-18C illustrate an example of image division.

FIG. 19 is a diagram illustrating a hardware configuration of an image processing device.

### DESCRIPTION OF EMBODIMENTS

Digital cameras (or electronic cameras) are sometimes required to have a function for suppressing the influence of camera shakes. Here, shortening the exposure time for image shooting suppresses the influence of camera shakes. However, noise may be caused in the image when the exposure time is short. Accordingly, in electronic camera-shake corrections, a plurality of images obtained via continuous shooting are combined to suppress random noise. As a result, thanks to short-period-exposure shooting and image synthesis, a camera-shake corrected image may be obtained in which only a small influence of camera shakes is recognized and noise is suppressed.

FIG. 5 is a flowchart of an example of the camera shake correcting process. In this example, two images obtained by continuous shooting are used to correct camera shake.

In step S1, two images (first and second images) are generated by continuous shooting with a shorter exposure time than usual. In step S2, the amount of displacement of the second image with respect to the first image is calculated. In step S3, the second image is transformed to correct the calculated amount of displacement. In step S4, the first image is combined with the transformed second image. Thus, the camera-shake corrected image is generated.

In the prior arts, the affine transformation or the like was performed in step S3 in FIG. 5. As described above, however, the affine transformation requires a lot of operations. In the image processing methods in accordance with the embodiments, by contrast, the second image is simply translated in step S3 in FIG. 5. A translation of an image is achieved by simply shifting the coordinates of pixels, and hence only a small number of operations are needed. Image processing devices and image processing methods in accordance with embodiments will be described in the following. In image processing methods in accordance with the embodiments, step S2 in FIG. 5 is not essential.

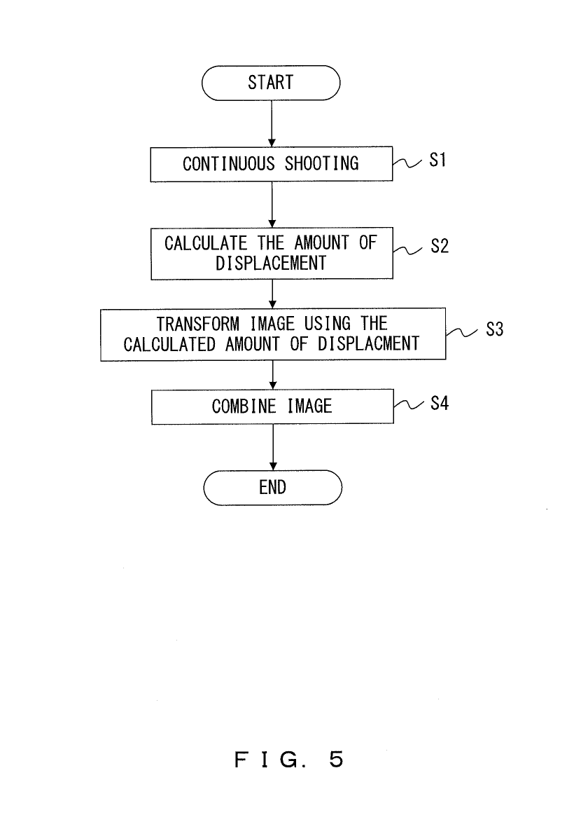

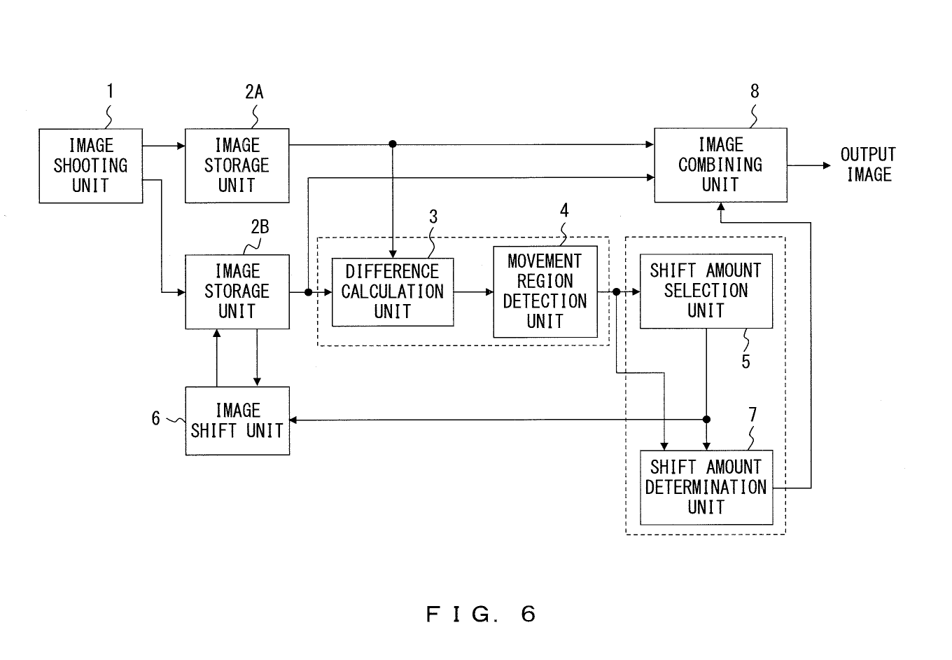

FIG. 6 is a diagram illustrating a configuration of an image processing device in accordance with a first embodiment. The image processing device may be installed within a digital camera (or an electronic camera).

An image shooting unit 1 is configured by, for example, a CCD image sensor or a CMOS image sensor, and generates a digital image. The image shooting unit 1 is provided with a continuously shooting function. In this Example, the image shooting unit 1 can obtain a plurality of images (first and second images) shot in a short period of time using one operation on the shutter of a camera.

Image storage units 2A and 2B respectively store the first and second images obtained by the image shooting unit 1. The image storage units 2A and 2B are, for example, semiconductor memory. The first and second images are any two of a plurality of images obtained via continuous shooting. The first image may be an image which was shot before the second image or may be an image which was shot after the second image. When the second image is transformed by an image shift unit 6, this transformed second image (a transformed image) may also be stored in the image storage unit 2B.

A difference calculation unit 3 calculates the difference between one set of images stored in the image storage units 2A and 2B. That is, a difference image is created. The difference between the pixel values of each pixel of the one set of images is calculated. The pixel value includes luminance data and color data; in this example, however, the difference in luminance data of pixels is calculated.

A movement region detection unit 4 refers to the result of an operation of the difference calculation unit 3 to detect a pixel having a difference in the pixel value between the images which is higher than a threshold determined in advance. The region in which the difference between pixel values is higher than the threshold may be hereinafter referred to as a “movement region”. A movement region is generated due to, for example, a camera shake caused during image shooting. However, a region in which the same pixel values are uniformly spread out (e.g., a region of a landscape image in which the blue sky is spread out) does not become a movement region even if a camera shake occurs, because the pixel values of pixels are not different from those of the corresponding image.

A shift amount selection unit 5 selects shift amounts (X direction movement amount and Y direction movement amount) for transforming the second image. The shift amount may be selected from those within a range determined in advance. The shift amount is represented in units of pixels. That is, the shift amount is represented by integers (including 0 and negative values) which indicate the amount of shift in the horizontal direction and that in the vertical direction.

An image shift unit 6 shifts each pixel of the second image stored in the image storage unit 2B in the horizontal direction and/or the vertical direction in accordance with the shift amount selected by the shift amount selection unit 5. This shifting process is achieved by, for example, shifting the address of each pixel by the same amount in image data in which the addresses and pixel values of the pixels are associated. For example, when the selected shift amount is “dx=10, dy=5”, the image shift unit 6 shifts the coordinates (address) of each pixel of the second image by ten pixels in the X direction and by five pixels in the Y direction.

The difference calculation unit 3, the movement region detection unit 4, the shift amount selection unit 5, and the image shift unit 6 detect a corresponding movement region while changing the shift amount (this will be described in detail hereinafter). In this case, a shift amount determination unit 7 determines a shift amount such that a movement region detected by the movement region detection unit 4 satisfies a specified condition. When the movement region satisfies the specified condition, the shift amount determination unit 7 outputs an image combining instruction.

When an image combining unit 8 receives the image combining instruction from the shift amount determination unit 7, the image combining unit 8 combines a set of images stored in the image storage units 2A and 2B. At this time, the image storage unit 2A stores a first image, and the image storage unit 2B stores a second image which has been shifted so that the movement region satisfies the specified condition. In other words, the first image and the transformed second image are combined.

If pixel values (including luminance data and color data) of the set of images are added to each other, a double-image of the movement region will appear in the combined image. In other words, the image is blurred. Accordingly, for the movement region, the image combining unit 8 outputs the pixel values of one image of the set of images (e.g., the first image) without adding the pixel values.

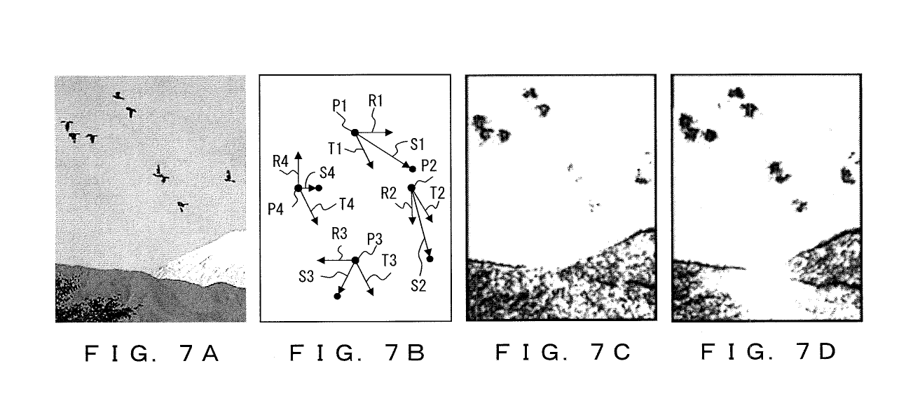

FIGS. 7A-7D illustrate an outline of an image combining method in accordance with the first embodiment. Note that FIG. 7A indicates one of the first and second images obtained via continuous shooting.

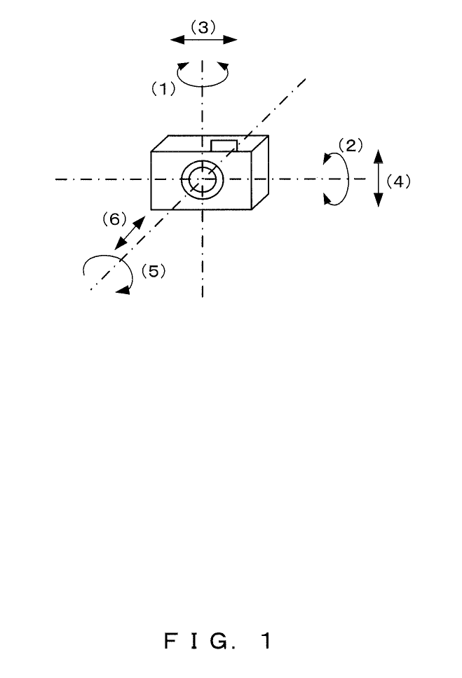

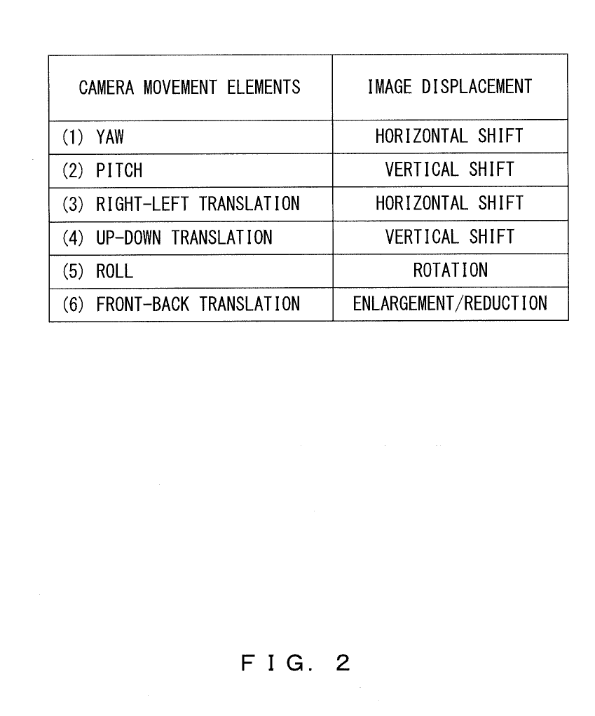

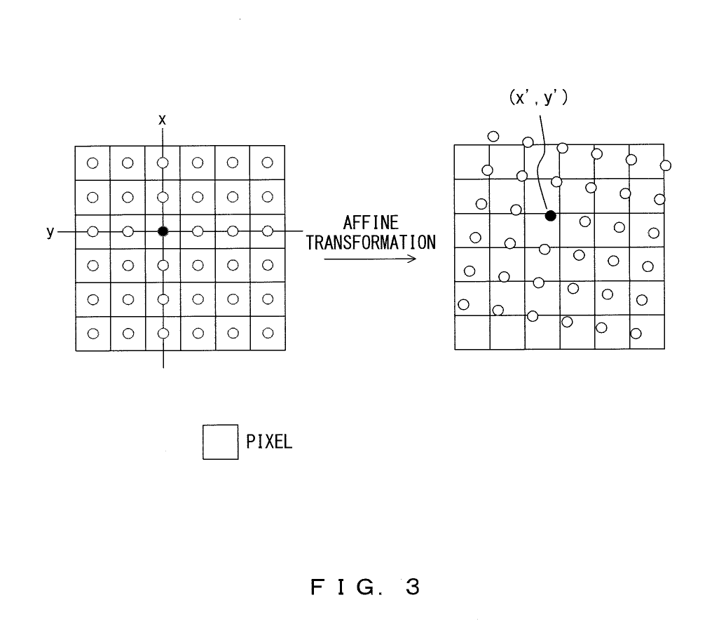

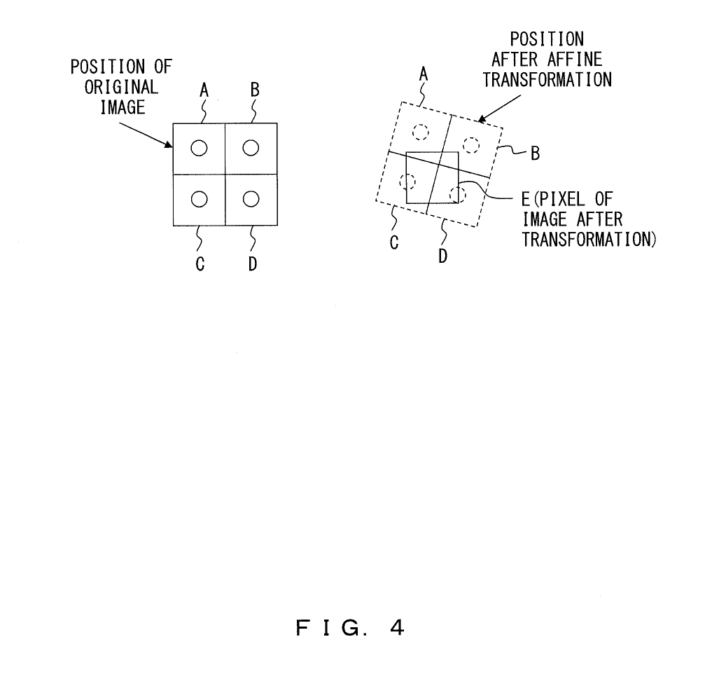

FIG. 7B indicates a positional displacement between the first and second images caused by a camera shake. Camera shakes occur due to the six elements illustrated in FIG. 1. Here, the positional displacements due to the right-left translations and the up-down translations are the same for all the coordinates of the image. The positional displacements due to YAW and PITCH are approximately the same for all the coordinates of the image. Accordingly, positional displacements due to these four elements are almost the same for all the coordinates of the image. That is, in FIG. 7B, translation vectors T1 to T4, which represent translation components of positional displacements of pixels P1 to P4 between the first and second images (i.e., the sum of positional displacements due to right-left direction movement, up-down direction movement, YAW, and PITCH), are approximately identical to each other.

By contrast, the components of camera shakes caused by ROLL (i.e., rotational components) are different depending on the coordinates in the image. That is, rotation vectors R1 to R4, which represent the rotational components of a camera shake with respect to the pixels P1 to P4, are different from each other. In the example illustrated in FIG. 7B, the pixel P1 moves rightward, the pixel P2 moves downward, the pixel P3 moves leftward, and the pixel P4 moves upward. As with positional displacements due to ROLL, positional displacements due to front-back translations are also different depending on coordinates in the image. Positional displacements due to front-back translations, however, are usually smaller than those due to ROLL. Accordingly, positional movements due to front-back translations will be ignored here. As a result, vectors S1 to S4, which represent positional displacements of the pixels P1 to P4, will respectively be the sums of the translation vectors T1 to T4 and the rotation vectors R1 to R4.

In the image processing methods in accordance with the embodiments, to simplify an alignment process for combining the first and second images, alignment is achieved by translating the images. The alignment process may be, for example, a translation process for compensating for the translation vectors T1 to T4 in FIG. 7B.

FIG. 7C illustrates a difference image corresponding to the difference between the first image and the second image in which the translation vectors T1 to T4 are compensated. In FIG. 7C, the regions in which the differences in the pixel value between the set of images are higher than a threshold (i.e., movement regions) are shown in black. In this case, the movement regions are large since rotational components are not compensated.

If the set of images are combined in this case, the images of the movement regions will appear as double-images in the combined image. In other words, the images are blurred. For the movement regions, accordingly, the image combining unit 8 outputs the pixel values of one of the set of images (e.g., the first image) without adding the pixel values, as described above. However, the noise reduction effect which would be achieved by image combining is obtained in a region in which only one of the images is used, and hence the image quality may be degraded (or the image quality would be unable to be improved). Accordingly, it will be favorable in the image combining processing if the movement regions are small.

In an image processing method in accordance with the first embodiment, the second image is shifted to make a movement region small, and the first image and the shifted second image are combined. In this case, movement regions are not really distributed uniformly throughout the entire image. In the example illustrated in FIG. 7C, many movement regions are included in the lower region of the image. In this case, the shift amount of the second image is determined so that positional displacements of pixels caused in the lower region of the image are compensated for. In the example illustrated in FIG. 7B, shift processing is applied to the entirely of the second image such that a camera-shake vector S3 of the pixel P3 is compensated for.

FIG. 7D illustrates a difference image corresponding to the difference between the first image and the second image to which shift processing has been applied to compensate for positional displacements in the lower region. This difference image has smaller movement regions (i.e., regions shown in black) than those illustrated in the example of FIG. 7C. Accordingly, the regions in which images are combined become larger, and hence noise in the combined image is reduced. When shift processing is applied to compensate for positional displacements within the lower region as indicated in FIG. 7D, the amount of displacement in the upper region may become large. In this example, however, there are only a few movement regions in the upper region. That is, the upper region is a region which indicates a small change in pixel value. Accordingly, even when there is a large positional displacement between the first and second images, the degradation of the image quality of the combined image is not easily recognized. Thus, as a whole, only a small amount of noise is recognized in combined images obtained using the method in accordance with the first embodiment.

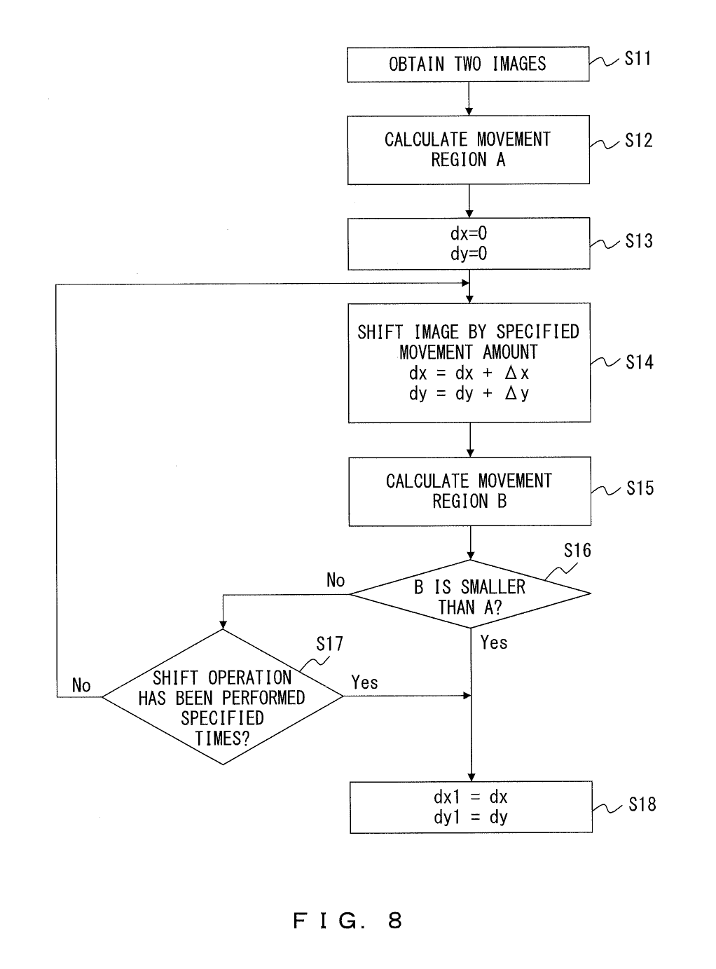

FIG. 8 is a flowchart illustrating a procedure for calculating a shift amount in the first embodiment. “dx” and “dy” represent shift amounts of coordinates of each pixel, and both of them are integers. The coordinate transformation achieved by shift processing (a translation) is represented by the following formula (2).

$$( \begin{matrix}{x}^{′} \\ {y}^{′} \\ 1\end{matrix} ) = ( \begin{matrix}1 & 0 & dx \\ 0 & 1 & dy \\ 0 & 0 & 1\end{matrix} ) ( \begin{matrix}x \\ y \\ 1\end{matrix} ) \qquad ( 2 )$$

“dx” represents a shift amount in the horizontal direction, and “dy” represents a shift amount in the vertical direction. (x, y) represents coordinates of an image before transformation, and (x′, y′) represents coordinates of the image after transformation. In the first embodiment, however, the matrix operation indicated by the formula (2) does not need to be carried out, but the image transformation is achieved by, for example, shifting the address of each pixel in image data in which the address and the pixel value of each pixel are associated with each other.

In step S11, the image shooting unit 1 obtains two images (i.e., a first image and a second image) via continuous shooting. The first and second images are stored in the image storage units 2A and 2B, respectively.

In step S12, the difference calculation unit 3 generates a difference image corresponding to the difference between the first and second images. The movement region detection unit 4 detects a movement region within the difference image. As described above, a movement region is a region in which the absolute value of the difference in the pixel value between the images is higher than a specified threshold. The movement region obtained in step S12 is an initial movement region obtained from a set of images before image transformation, and this region will be hereinafter referred to as a “movement region A”.

In step S13, the shift amount selection unit 5 initializes variables dx and dy used for calculating the shift amount (i.e., the translation amount). In step S14, the image shift unit 6 shifts the coordinates of each pixel of the second image by the shift amounts dx and dy selected by the shift amount selection unit 5. That is, translation is performed on the second image. The second image after the coordinate shifting is written in the image storage unit 2B.

The shift amount selection unit 5 may select shift amounts dx and dy in accordance with an algorithm specified in advance. In this case, the shift amount selection unit 5 sequentially outputs different shift amounts dx and dy each time steps S14 to S17 are executed repeatedly. The following is an example of a sequence of the shift amounts to be selected.

(dx, dy)=“0, 3”→“0, 6”→“0, 9”→“0, 12”→“0, −3”→“0, −6”→“0, −9”→“0, −12”→“3, 0”→“3, 3”→“3, 6”→“3, 9”→“3, 12”→“3, −3”→“3, −6”→“3, −9”→“3, −12” . . . →“−12, −12”

In this example, each of dx and dy is selected from the range “from −12 to +12”. Both of the step sizes Δdx and Δdx is “3”. The range and the step sizes may be determined in accordance according to, for example, the image size (i.e., the number of the pixels in the image).

In step S15, the difference calculation unit 3 generates a difference image which corresponds to the difference between the first image and the second image after the coordinate shifting. The movement region detection unit 4 detects a movement region within the difference image. The movement region obtained in step S15 will be hereinafter referred to as a “movement region B”.

In step S16, the shift amount determination unit 7 compares the area of the movement region A with that of the movement region B. When the area of the movement region B is larger than or equal to that of the movement region A, then, in step S17, it is checked whether or not steps S14-S16 have been performed specified times. When steps S14-S16 have not been performed specified times yet, the process returns to step S14.

When the area of the movement region B is smaller than that of the movement region A, the shift amount determination unit 7 maintains the shift amounts dx and dy selected at that time by the shift amount selection unit 5. That is, the shift amounts dx and dy are determined. Here, the fact that the movement region B is smaller than the movement region A means that the new movement region has been made to be smaller than the initial movement region as a result of the shifting of the second image. In this way, in the method in accordance with the first embodiment, a shift amount of the second image is determined for making the movement region small. The shift amounts obtained in the image processing method in accordance with the first embodiment may be hereinafter referred to as “dx1, dy1”.

When the shift amount determination unit 7 determines the shift amounts dx and dy, the shift amount determination unit 7 outputs an image combining instruction. Upon receiving the image combining instruction, the image combining unit 8 combines a set of images stored in the image storage units 2A and 2B. At this time, the image storage unit 2A stores the first image. The image storage unit 2B stores the second image which has been shifted by the shift amounts dx and dy calculated in steps S11 to 18. That is, the first image and the shifted second image are combined.

As described above, in the image processing method according to the first embodiment, the second image is transformed to make the movement region associated with the first and second images small, and the first image and the transformed second image are combined. In this processing, the transformation of the second image is achieved by simply shifting the coordinates of each pixel on a pixel-by-pixel basis. Accordingly, only a small number of operations are needed to achieve image combining and to correct camera shakes.

Noise in the combined image depends on the size of a movement region associated with the first and second images as described above. That is, the size of a movement region is an index of noise in a combined image. Accordingly, the difference calculation unit 3 and the movement region detection unit 4 in FIG. 6 are operated as a noise level detection unit which detects a noise level. The shift amount selection unit 5 and the shift amount determination unit 7 are operated as a shift amount calculation unit which calculates a shift amount to make the noise level detected by the noise level detection unit small.

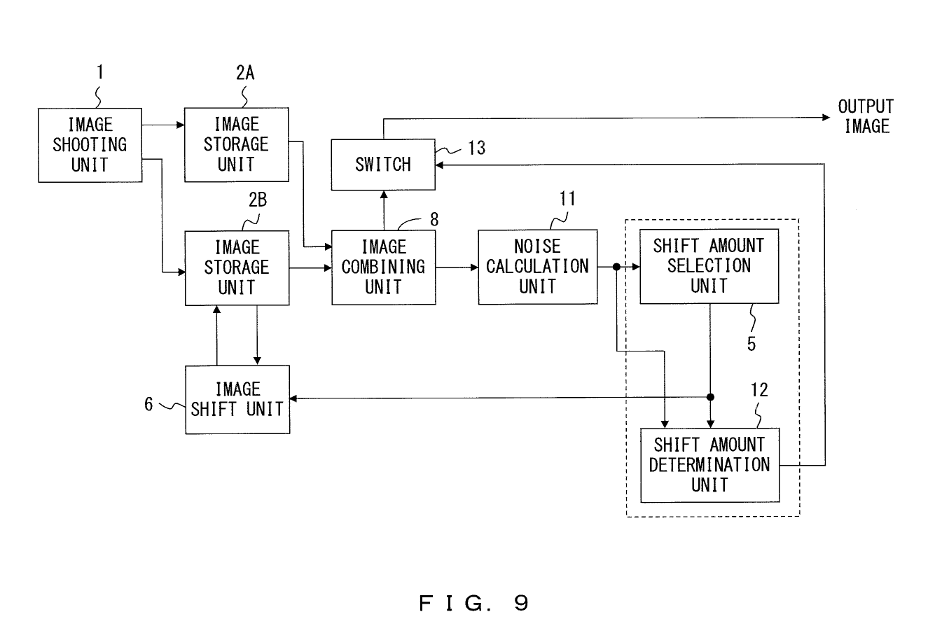

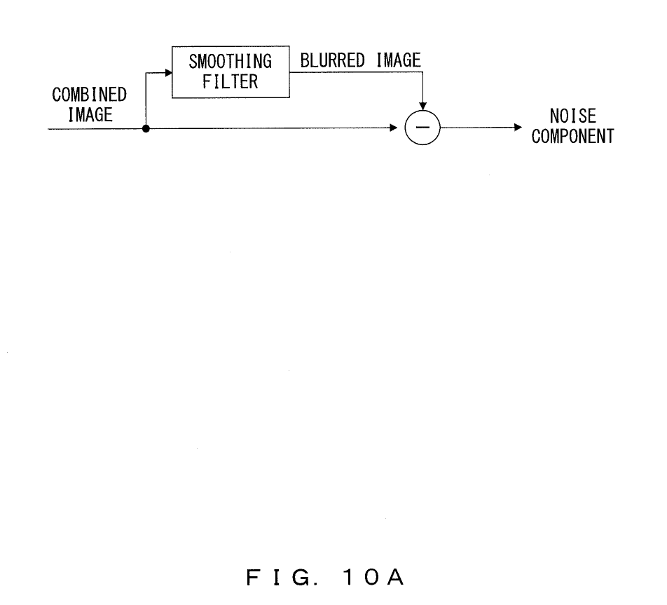

FIG. 9 is a diagram illustrating a configuration of an image processing device in accordance with a second embodiment. The image shooting unit 1, the image storage units 2A and 2B, the shift amount selection unit 5, the image shift unit 6, and the image combining unit 8 of the image processing device in accordance with the second embodiment are substantially the same as those in the first embodiment.

A noise calculation unit 11 calculates noisiness of a combined image generated by the image combining unit 8. The noisiness is calculated by extracting noise components of the combined image. The noise component is calculated by the following formula.

Noise component=original image−blurred image of original image

The noisiness is, for example, the sum of noise components calculated for the pixels. In this case, when the noisiness is high, the difference between the original image and the blurred image of the original image (i.e., noise components) is large and the sum of the noise components is large. On the other hand, when the noisiness is low, the difference between the original image and the blurred image of the original image (i.e., noise components) is small and the sum of the noise components is small. However, the noisiness is not limited to this example and may be represented by other parameter(s).

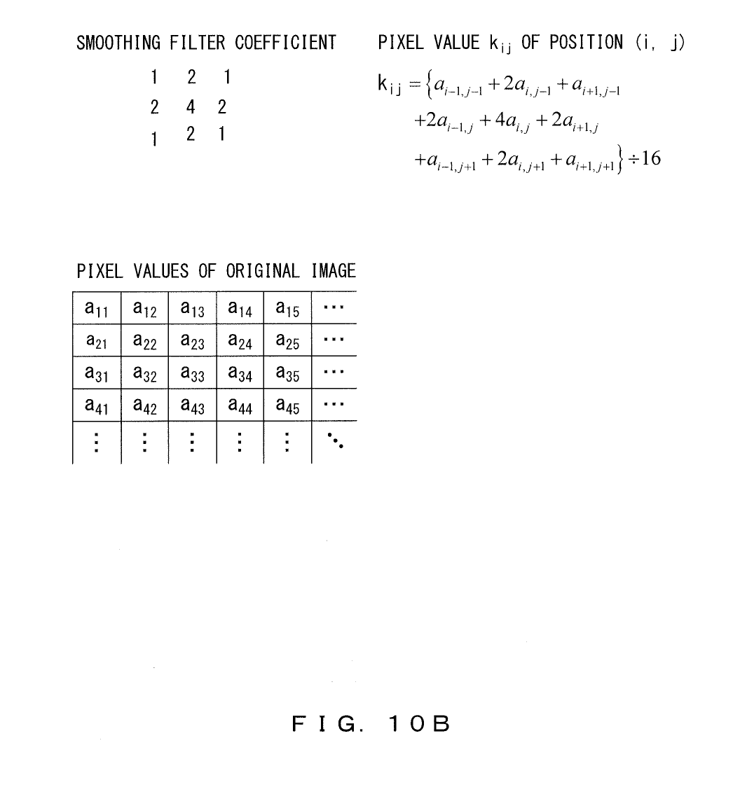

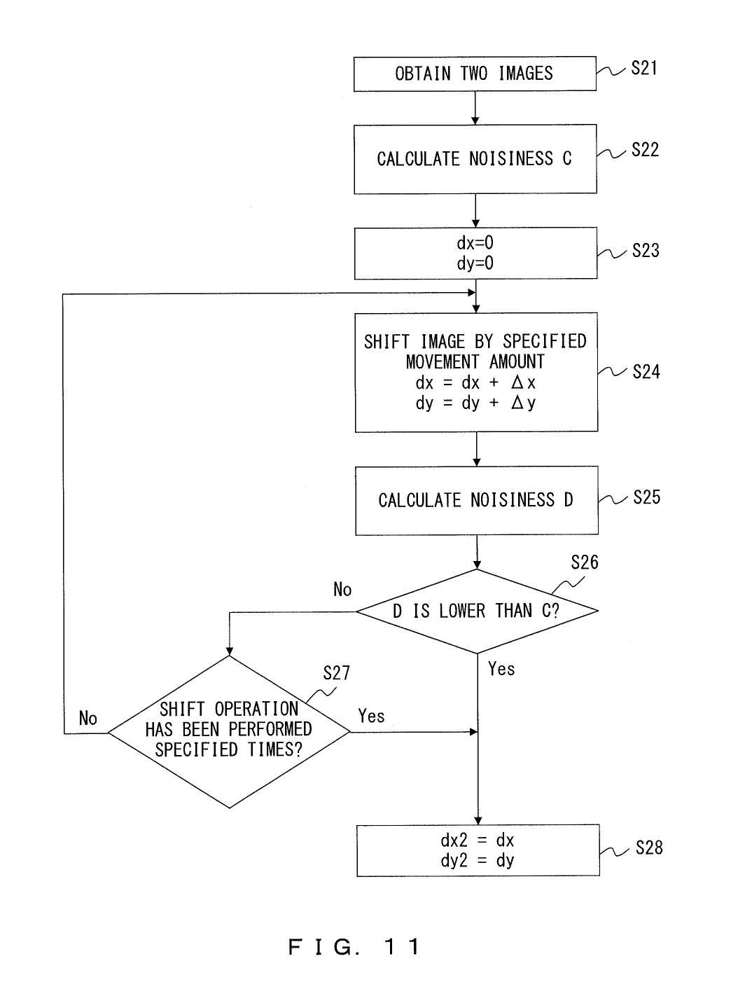

FIG. 10A is a diagram illustrating a method for extracting a noise component of a combined image. As illustrated in FIG. 10A, a blurred image is generated by applying a smoothing filter operation to the combined image. The smoothing filter is achieved by, for example, the operation illustrated in FIG. 10B. In addition, a difference is calculated between each pixel value of the original image and that of the blurred image obtained by the smoothing filter operation. Noise components of the combined image are obtained by calculating the sum of the absolute values of the differences in the pixel value.

A shift amount determination unit 12 determines a shift amount such that the noisiness calculated by the noise calculation unit 11 satisfies a specified condition. When the specified condition is satisfied by the noisiness, the shift amount determination unit 12 outputs an image combining instruction.

Upon receiving the image combining instruction from the shift amount determination unit 12, the switch 13 outputs the combined image generated by the image combining unit 8. In other words, when the noisiness of the combined image satisfies the specified condition, the combined image is output.

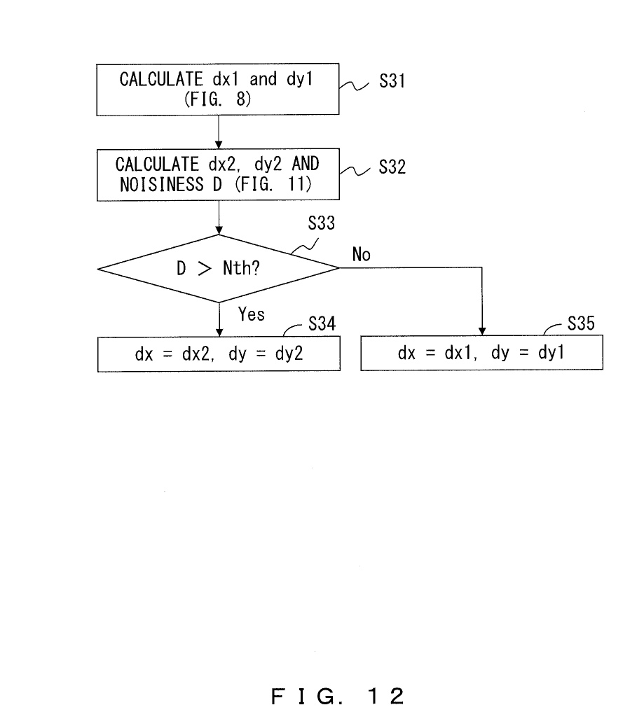

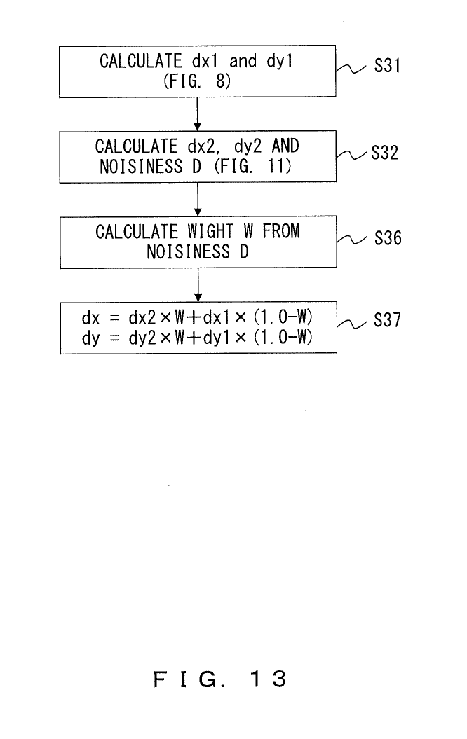

FIG. 11 is a flowchart illustrating a procedure for calculating a shift amount in the second embodiment. Also in the second embodiment, shift amounts dx and dy are calculated. The procedure of the second embodiment is similar to that of the first embodiment. However, although the shift amounts are calculated according to the area of a movement region in the first embodiment, they are calculated according to the noisiness in the second embodiment.

In step S21, the image shooting unit 1 obtains two images (the first and second images) via continuous shooting. In step S22, the noise calculation unit 11 calculates noisiness of a combined image of the first and second images. In the following descriptions, the noisiness obtained in step S22 will be referred to as “noisiness C”.

Steps S23 and S24 are substantially the same as steps S13 and S14 in the first embodiment. That is, the shift amounts dx and dy are initialized in step S23. In step S24, coordinate shifting is performed on the second image by the shift amounts dx and dy selected by the shift amount selection unit 5. In this case, the image combining unit 8 generates a combined image obtained by combining the first image and the second image on which coordinate shifting has been performed.

In step S25, noisiness of the newly generated combined image is calculated. The noisiness obtained in step S25 will be hereinafter referred to as “noisiness D”.

In step S26, the shift amount determination unit 12 compares the noisiness C with the noisiness D. When the noisiness D is greater than or equal to the noisiness C, then, in step S27, it is checked whether the steps S24-S26 have been performed specified times. The process returns to step S24 when the steps S24-S26 have not been performed specified times.

When the noisiness D is lower than the noisiness C, the shift amount determination unit 12 stores the shift amounts dx and dy selected at that time by the shift amount selection unit 5. That is, the shift amounts dx and dy for transformation of the second image are determined. Here, the situation in which the noisiness D is lower than the noisiness C means that noise in the combined image has been reduced by translating the second image. In this way, in the method according to the second embodiment, shift amounts of the second image are determined for reducing noisiness. The shift amounts obtained in the image processing method according to the second embodiment may be hereinafter referred to as “dx2 and dy2”.

After determining the shift amounts dx and dy, the shift amount determination unit 12 outputs an image combining instruction. Accordingly, the switch 13 outputs a combined image generated by the image combining unit 8. In this case, the image combining unit 8 generates a combined image with small amount of noise. As a result, combined images with a small amount of noisiness will be generated.

As described above, in the image processing method according to the second embodiment, the second image is transformed to reduce noisiness in a combined image of the first and second images, and the first image and the transformed second image are combined. In this case, the transformation of the second image is achieved by simply shifting the coordinates of each pixel. Accordingly, only a small number of operations are needed to achieve image combining and to correct camera shakes.

In the image processing device illustrated in FIG.9, the noise calculation unit 11 is operated as a noise level detection unit which detects a noise level. The shift amount selection unit 5 and the shift amount determination unit 12 are operated as a shift amount calculation unit which calculates a shift amount to make small a noise level (corresponding to noisiness in the second embodiment) detected by the noise level detection unit.

In the meantime, according to a property of noise in an image, image noise in a region in which pixel values vary gradually are more prominent than those in a region in which pixel values vary remarkably. This property is achieved due to a large variation in pixel values causing the noise to be buried under the variation in pixel values so that the human eye cannot easily distinguish the noise concentration difference. Accordingly, a region included in a blurred image and indicating a large variation in gray scale gradation (i.e., a region indicating a large variation in pixel value in the original image) may be weighted lightly and a region indicating a small variation in gray scale gradation may be weighted heavily, so that the noisiness Nr of the image may be quantified in the following formula.

Noisiness Nr=ΣΣk_{x,y}×w[s]
x: Horizontal direction coordinate in image
y: Vertical direction coordinate in image
k_{x,y}: Result of movement region decision of coordinates (x, y) (1: Movement region, 0: Non-movement region)
w[s]: Weighting factor with respect to gray-scale-gradation change s (e.g., w[0]=1, w[1]=2)

Here, in this Example, the gray-scale-gradation change s is “1” when parameter J is higher than a threshold, and it is “0” when parameter J is equal to or lower than the threshold.

J=abs{Y(x, y−1)−Y(x, y)}+abs{Y(x−1, y)−Y(x, y)}+abs{Y(x+1, y)−Y(x, y)}+abs{Y(x, y+1)−Y(x, y)}
“abs{ }” represents a function for calculating an absolute value.
“Y(i, j)” represents a luminance value at the coordinates (i, j) of the blurred image.

In accordance with the operation above, k_{x, y} is zero in a non-movement region, and hence the noise index of each pixel of the non-movement region is also zero. Meanwhile, the noise index of a movement region depends on gray-scale-gradation change s. That is, the noise index of a pixel belonging to a region indicating gray-scale-gradation change s which is higher than a threshold Nth is “1”, and the noise index of a pixel belonging to a region indicating gray-scale-gradation change s which is equal to or lower than the threshold Nth is “2”. The noisiness Nr is obtained by calculating the sum of the noise indexes of the pixels. The noisiness Nr may be calculated in steps S22 and S25 in the flowchart of FIG. 11.

FIG. 12 is a flowchart illustrating a procedure for calculating a shift amount by using the first and second embodiments.

In step S31, the processes in the flowchart of FIG. 8 are executed. That is, the shift amounts dx1 and dy1 are calculated. In step S32, the processes in the flowchart of FIG. 11 are executed. That is, the shift amounts dx2 and dy2 and the noisiness D are calculated.

In step S33, the noisiness D is compared with the threshold Nth. The noisiness D represents the noisiness of a combined image obtained by combining the first image and the shifted second image. When the noisiness D is higher than the threshold Nth, then, in step S34, the shift amounts dx2 and dy2 are output. In this case, the second image is shifted by the shifts amounts dx2 and dy2, and a combined image obtained by combining the first image and the shifted second image is generated. Meanwhile, when the noisiness D is lower than or equal to the threshold Nth, then, instep S35, the shift amounts dx1 and dy1 are output. In this case, the second image is shifted by the shift amounts dx1 and dy1, and a combined image obtained by combining the first image and the shifted second image is generated.

According to the procedure above, when an image includes large amount of noisiness, image shifting is performed on the image in such a way that the noisiness is reduced. When an image includes small amount of noisiness, image shifting is performed on the image in such a way that a movement region is decreased (i.e., in such a way that the areas of portions to be combined become large). That is, an image combining method is selected in accordance with the property of an image. As a result, the precision of camera-shake correction is improved.

FIG. 13 is a flowchart illustrating another procedure for calculating a shift amount by using the first and second embodiments. Note that steps S31 and S32 are substantially the same as those in FIG. 12.

In step S36, a weighting factor W is calculated in accordance with the noisiness D. As an example, the weighting factor W is determined as follows.
(1) W=1 when noisiness Nr is higher than the threshold Nth
(2) W=Nr/Nth when noisiness Nr is equal to or lower than the threshold Nth

Then in step S37, in accordance with the shift amounts dx1 and dy1 obtained in step S31, the shift amounts dx2 and dy2 obtained in step S32, and the weighting factor W obtained in step S36, shift amounts dx and dy are calculated for generating a transformed second image. The shift amounts dx and dy are calculated using, for example, the following formulae.

dx=dx1×(1−W)+dx2×W

dy=dy1×(1−W)+dy2×W

As described above, in the procedure in FIG. 13, when the image includes large amount of noisiness, the shift amount of the second image is determined based on the noisiness. On the other hand, when the amount of noisiness is small, the shift amount of the second image is determined in accordance with both the movement region and the noisiness. That is, also in this procedure, an image combining method is selected in accordance with the property of an image. As a result, the precision of camera-shake correction is improved.

In the flowchart in FIG. 8, when a shift amount to reduce the movement region is calculated, the second image is shifted by this shift amount. In the flowchart in FIG. 11, when a shift amount to suppress the noisiness is calculated, the second image is shifted by this shift amount. However, the methods in accordance with the first and second embodiments are not limited to these procedures. That is, as an example, in the method in accordance with the first embodiment, a shift amount to minimize the movement region may be calculated, and the second image may be shifted by this shift amount. Similarly in the method in accordance with the second embodiment, as an example, a shift amount to minimize the noisiness may be calculated, and the second image may be shifted by this shift amount.

Two input images are combined in the aforementioned examples; however, the image processing device in accordance with the embodiments may generate a combined image using three or more images. Assume as an example that first to third images are input and the first image is a reference image. In this case, image transformation of coordinate shifting is performed for each of the second and third images. Then the image combining unit 8 combines the first image, the transformed second image, and the transformed third image. Alternatively, the image combining unit 8 may combine the transformed second image and the transformed third image.

In addition, the image processing device illustrated in FIG. 6 or 9 may be realized using a hardware circuit. Alternatively, a portion of the function of the image processing device may be realized using software. For example, some or all of the difference calculation unit 3, the movement region detection unit 4, the shift amount selection unit 5, the image shift unit 6, the shift amount determination unit 7, the image combining unit 8, the noise calculation unit 11, the shift amount determination unit 12, and the switch 13 may be realized by using software.

### Other Embodiment 1

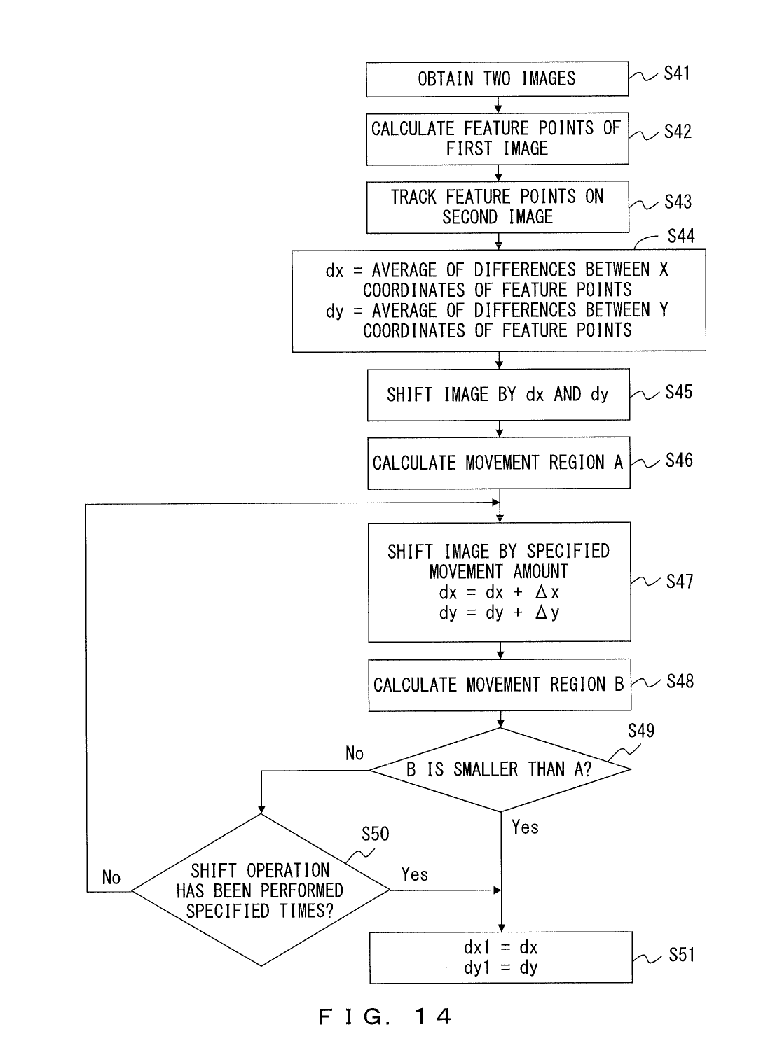

FIG. 14 is a flowchart illustrating an image processing method in accordance with another embodiment. In this image processing method, the translation component (i.e., the sum of positional displacements due to right-left direction movement, up-down direction movement, YAW, and PITCH) of camera shake between the first and second images is calculated. Then the shift amount of the second image is calculated using the translation component of camera shake as an initial value of the calculation.

In step S41, the first and second images are obtained. In step S42, a plurality of feature points of the first image are extracted. In step S43, the feature points are tracked in the second image. As a result of steps S41 to S43, the amount of displacement between the first and second images is calculated. The amount of displacement between images may be calculated in, but not particularly limited to, the following procedure.
(1) The feature value of each pixel of the first image stored in the image storage unit 2A is calculated. The feature value of each pixel is calculated using, for example, the KLT method or the Moravec operator. One or more pixels with a higher feature value than a specified threshold level are extracted as feature points. In this case, it is preferable that a plurality of feature points be extracted.
(2) The feature points extracted from the first image are searched for in the second image stored in the image storage unit 2B.
(3) The movement amount (motion vector) of each feature point is calculated between the first and second images.
(4) The translation amount (dx, dy), the rotation angle (θ), and the enlargement/reduction rate S of the positional displacement between the two images are calculated in accordance with the movement amount of each feature point. The translation amount is represented in units of pixels.

In step S44, the average of the X direction movement amount of each feature point is set as the initial value of variable dx. The average of the Y direction movement amount of each feature point is set as the initial value of variable dy. In step S45, coordinate shifting of the second image is performed by dx and dy set in step S44. Note that the positional displacement due to the rotation and enlargement/reduction is approximately canceled. In step S46, a movement region associated with the first image and the second image after the coordinate shifting (i.e., a movement region A) is detected.

Steps S47 to S51 are substantially the same as steps S14 to S18 in FIG. 8. That is, a movement region B is detected, and the movement regions A and B are compared to each other. When the movement region B is smaller than the movement region A, the shift amount selected at that time is output.

According to this procedure, the translation component in the positional displacement between the first and second images is set as the initial value, and hence the amount of processing required to calculate a shift amount for making the movement region small is reduced. Assume as an example that the shift amount is selected from the range from “−12” to “+12” and that the translation components of the positional displacement between the images are “X direction: +9, Y direction: +6”. In this case, the shift amount dx may be selected from, for example, the range from “+6” to “+12”, and the shift amount dy may be selected from, for example, the range from “+3” to “+9”.

As described above, using the procedure indicated in FIG. 14, a transformed image for image combining is also generated by only shifting the coordinates of the second image. In this case, the shift amount of the second image includes the rotational component and the enlargement/reduction component of camera shake. Accordingly, the quality of combined images is improved more than in the case of a method in which only the translation component of the positional displacement between images is compensated for.

### Other Embodiment 2

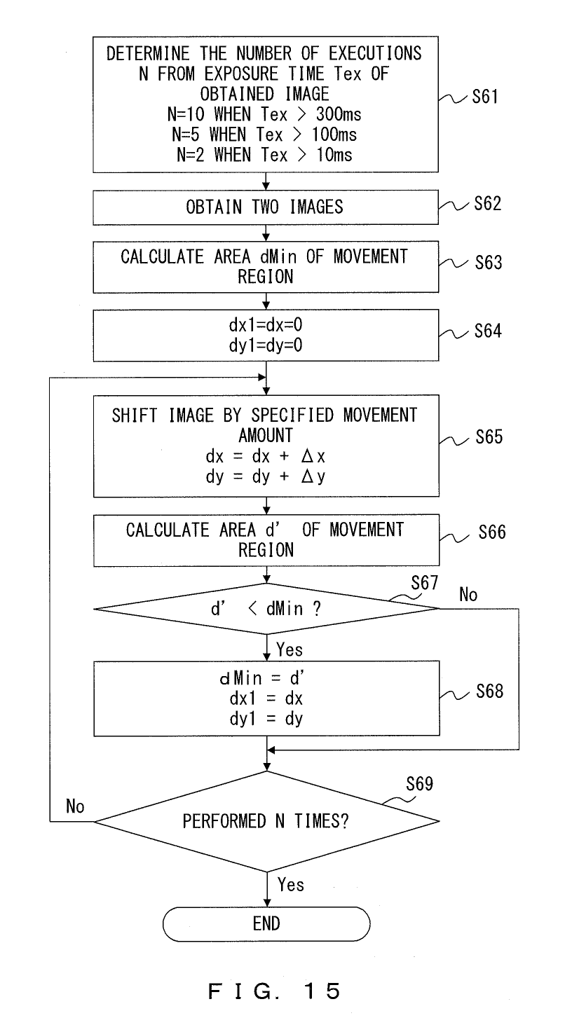

FIG. 15 is a flowchart illustrating an image processing method in accordance with still another embodiment. In this embodiment, image processing is performed in consideration of the exposure time of the camera (i.e., the image shooting unit 1). The exposure time may be automatically decided on by the camera or may be specified by the user.

In step S61, the number of executions N is determined in accordance with the exposure time of the image shooting unit 1. Note that N is the number of executions of steps S65 to S68. In step S62, the first and second images are obtained. In step S63, the area dMin of a movement region associated with the first and second images is calculated. The area of the movement region corresponds to, for example, the number of pixels with a difference in the pixel value between the first and second images that is higher than a specified threshold. In the following processes, dMin is used as a variable for searching for a smaller movement region. In step S64, variables dx and dy for calculating a shift amount are initialized.

In step S65, the second image is shifted by a shift amount selected by the shift amount selection unit 5, similar to step S14 in FIG. 8. In step S66, an area d′ of a movement region associated with the first image and the shifted second image is calculated. In step S67, the area dMin is compared with the area d′.

When the area d′ is smaller than the area dMin, then, in step S68, d′ is assigned to dMin used as a variable. In addition, the shift amounts dx and dy selected in step S65 are assigned to variables dx1 and dy1. When the area d′ is larger than or equal to the area dMin, step S68 is skipped.

In step S69, it is checked whether the number of executions of steps S65 to S68 has reached “N”. “N” is determined in step S61 in accordance with the exposure time of the image shooting unit 1. When the number of executions reaches “N”, the process for searching for an appropriate shift amount is terminated.

In this way, in the method illustrated in FIG. 15, shift amounts dx and dy are calculated for minimizing a movement region, during executions, the number of which is determined in accordance with the exposure time. Here, when the exposure time is long, the positional displacement between the first and second images tends to be large. Accordingly, when the exposure time is long, appropriate shift amounts may be selected from a wide range by performing steps S65 to S68 many times. Meanwhile, the positional displacement between the first and second images tends to be small when the exposure time is short, and hence appropriate shift amounts should also be small. Accordingly, appropriate shift amounts may be obtained even if the number of executions of step S65 to S68 is small. As a result, the number of operations may be reduced.

### Other Embodiment 3

The range of selection of a shift amount is determined in accordance with a positional displacement caused by the rotation or the front-back direction movement of the camera.

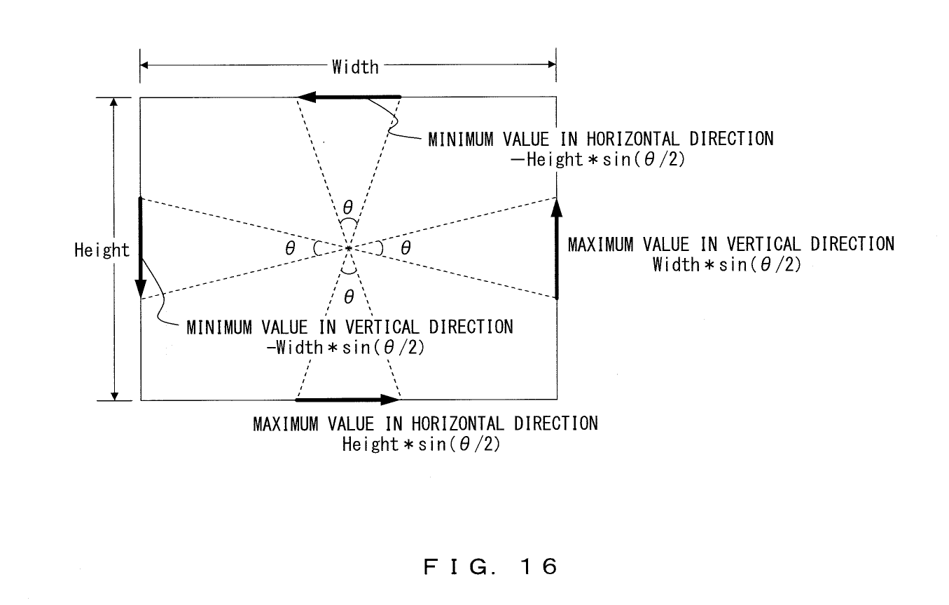

Assume as an example that the number of pixels of a shot image is “Height×Width” and the possible maximum value of the angle of the camera rotation made during the shooting is θ. In this case, as indicated in FIG. 16, the amount of shift in horizontal direction for compensating for the rotation of the camera is within the range from “−Height×sin(θ/2)” to “+Height×sin(θ/2)”. The amount of shift in vertical direction for compensating for the rotation of the camera is within the range from “−Width×sin(θ/2)” to “+Width×sin(θ/2)”. Accordingly, the number of operations will become small if the second image is transformed in accordance with the shift amount selected from the range above to combine the first and second images. It should be noted that the method in which the number of operations is made small by limiting the selection range of the shift amount is also effective for compensation of displacement components caused by the front-back direction movement of a camera. In the following, a method for calculating a shift amount within a range that is limited in accordance with the rotation or the front-back direction movement of a camera will be described with reference to FIG. 17.

In step S71, the first and second images are obtained. In step S72, the selection range of the shift amount is specified. In this example, the range of the shift amount in horizontal direction is from −dx0 to +dx0, and the range of the shift amount in vertical direction is from −dy0 to +dy0. These ranges are determined using, for example, the method which was described with reference to FIG. 16. The values dx0 and dy0 are integers.

In step S73, area dMin of a movement region associated with the first and second images is calculated. In the following processes, dMin is used as a variable for searching the minimum movement region. In step S74, variables for calculating shift amounts are initialized. The minimum value of each range is given as an initial value. In this example, the minimum values are −dx0 and −dy0.

The processes of steps S75 to S78 are similar to those of steps S65 to S68 in FIG. 15. In this case, however, an operation for dx is carried out while dy is set to be a fixed value. That is, the second image is shifted by a selected shift amount, the area d′ of a movement region associated with the first image and the shifted second image is calculated, and the area dMin is compared with the area d′. When the area d′ is smaller than the area dMin, d′ is assigned to the variable dMin. In addition, the shift amount dx selected in step S75 is assigned to the variable dx1. When the area d′ is larger than or equal to the area dMin, step S78 will be skipped.

Step S79 is provided for scanning the shift amount in horizontal direction from “−dx” to “+dx” while fixing the shift amount in vertical direction. Steps S80 and S81 are provided for scanning the shift amount in vertical direction from “−dy” to “+dy” while fixing the shift amount in horizontal direction.

As described above, in the method illustrated in FIG. 17, a shift amount is calculated such that a movement region is minimized within the range specified as initial values. Then, the second image is transformed by the shift amount, and a combined image obtained by combining the first image and the transformed second image is generated. Accordingly, in generating a combined image, the area of combined regions is maximized, thereby minimizing noise. The methods illustrated in FIGS. 14 and 17 may be used in combination with each other. That is, the initial values of the shift amounts dx and dy may be set in accordance with the translation component of a positional displacement between images caused by a camera shake, and the selection range of the shift amounts may be set in accordance with the maximum value of the rotation angle of the camera.

According to the descriptions of the aforementioned three embodiments (i.e., other embodiments 1 to 3), shift amounts are calculated for making movement regions small; in all of these embodiments, however, shift amounts may be calculated for making noisiness small.

### Other Embodiment 4

In image processing methods in which a camera shake is corrected by combining a plurality of images, image qualities of a region including many movement regions or of a region with strong noisiness are likely to be degraded. In this embodiment, accordingly, a region including many movement regions or a region with strong noisiness is extracted as an particular region. The processes illustrated in the flowcharts in FIG. 8, FIG. 11, FIG. 12, FIG. 13, FIG. 14, FIG. 15, and/or FIG. 17 are executed on the particular region. According to this method, a small number of operations are needed to generate a high-quality combined image.

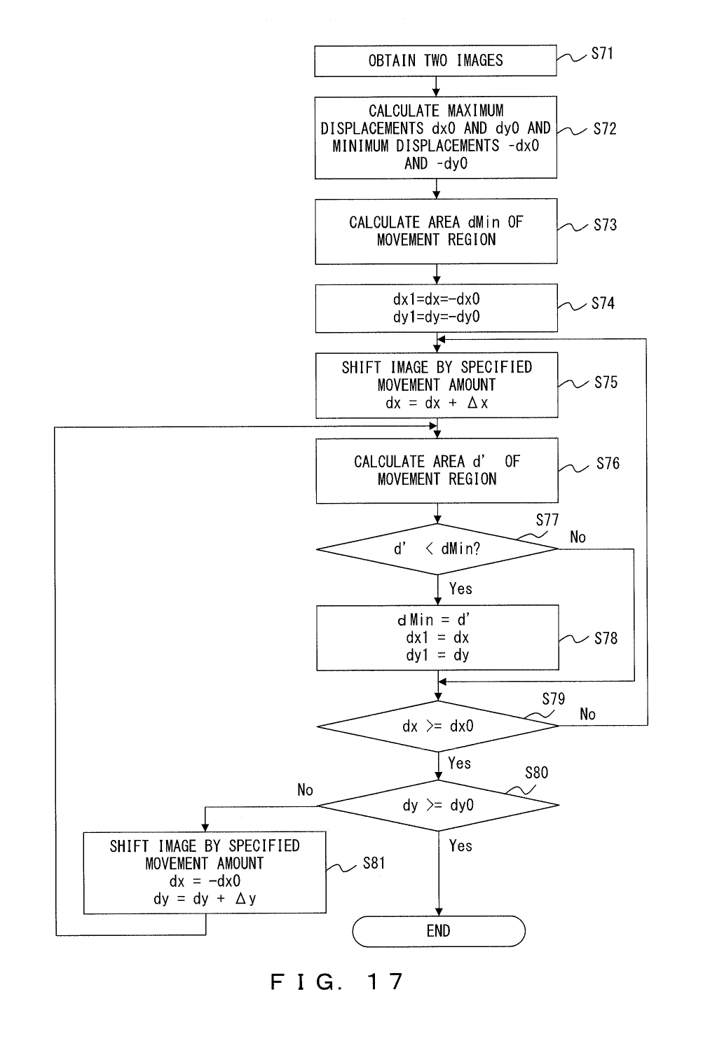

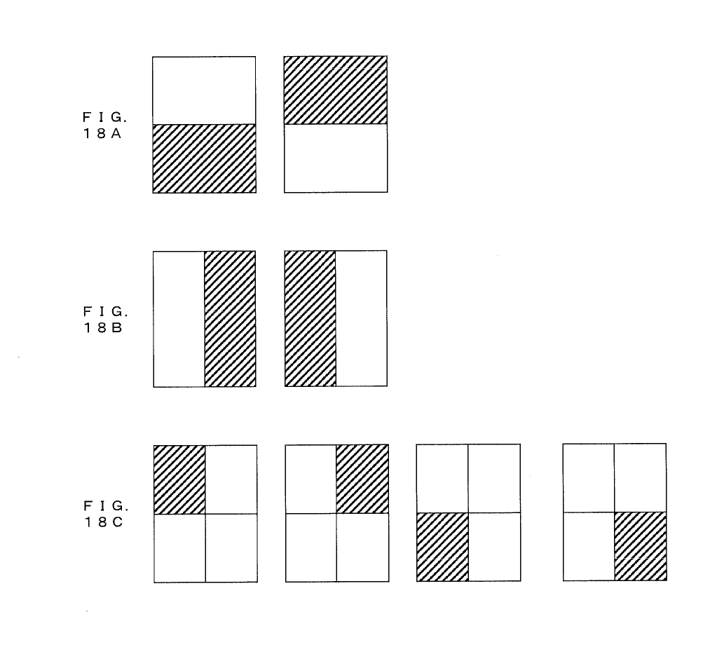

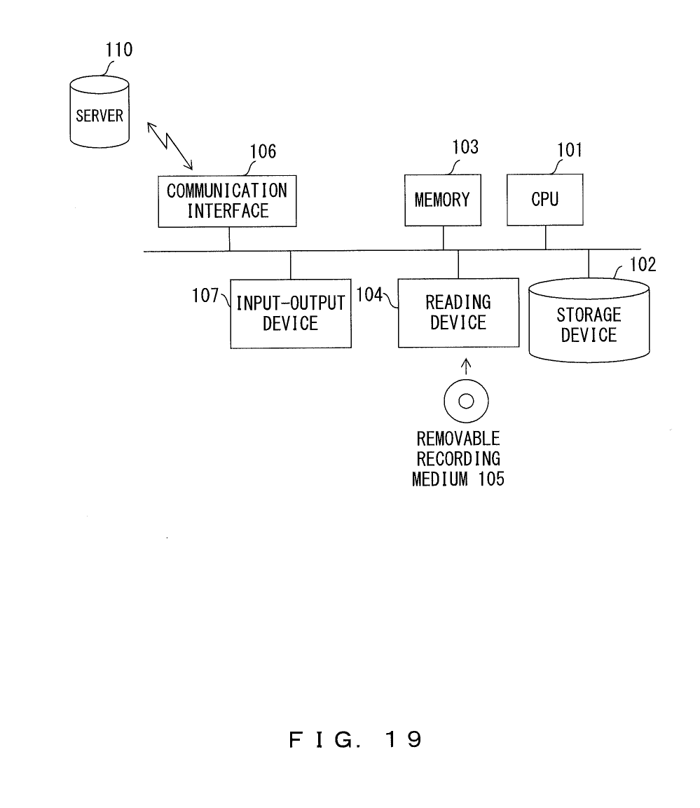

The particular region is established by, for example, dividing an image into a plurality of blocks and calculating noisiness or the area of a movement region for each block. In FIG. 18A, an image is divided into an upper block and a lower block. In FIG. 18B, an image is divided into a right block and a left block. In FIG. 18C, an image is divided into four blocks. In this case, a block including the largest movement region or a block with the strongest noisiness is selected as a particular region. Alternatively, a block including a movement region having an area greater than a specified threshold or a block with noisiness that is greater than a specified threshold level may be selected as an particular region.

It should be noted that one shift amount may be calculated for one image or one shift amount may be calculated for each block.

In a method in which an particular region is detected as described above, a combined image may be generated using the following procedure.
(1) Specify a region in which a difference in the pixel value between the first and second images is larger than a threshold.
(2) Calculate a motion vector between the first and second images for pixels within the specified region.
(3) Generate a transformed image by shifting the coordinates of each pixel of the second image in accordance with the calculated motion vector.
(4) Combine the first image and the transformed image to generate a combined image.

<Common Features>

In the embodiments described with reference to FIGS. 6 to 18, a noise level is detected in accordance with the first and second images. In the first embodiment, the noise level corresponds to the area of a movement region associated with the first and second images. In the second embodiment, the noise level corresponds to noisiness.

In each of the embodiments, a shift amount is calculated for making a noise level small. The process for making the noise level small may be selected from at least the following three algorithms.
(1) Terminate the operation at a moment at which the noise level of a combined image obtained by combining the first image and the transformed second image becomes smaller than a noise level that would be achieved if the first and second images are combined without the transformation.
(2) Minimize the noise level.
(3) Minimize the noise level during execution of a specified number of operations.

In addition, the image processing methods in accordance with the embodiments may be applied not only to camera shake correction, but also to other image combining technologies. As an example, the methods in accordance with the embodiments may be applied to mosaicing processes.

As long as there is no contradiction, the aforementioned embodiments may be combined with each other.

<Hardware Configuration>

FIG. 19 is a diagram illustrating a hardware configuration of the image processing device in accordance with the embodiments (or a computer which executes the image processing methods). In FIG. 19, a CPU 101 executes an image processing program by using a memory 103. A storage device 102 stores the image processing program. The storage device 102 may be an external storage apparatus. The memory 103 is, for example, a semiconductor memory, and the memory 103 includes a RAM region and a ROM region.

A reading device 104 accesses a removable recording medium 105 in accordance with an instruction from the CPU 101. The removable recording medium 105 may be realized by, for example, a semiconductor device (e.g., a PC card), a medium to or from which information is input or output through a magnetic action, and a medium to or from which information is input or output through an optical action. A communication interface 106 transmits and receives data through a network in accordance with an instruction from the CPU 101. In this Example, an input/output device 107 corresponds to a camera, a display device, a device which receives an instruction from the user, and the like.

The image processing programs in accordance with the embodiments are provided in, for example, the following forms.
(1) Installed in the storage apparatus 102 in advance
(2) Provided by the removable recording medium 105
(3) Downloaded from a program server 110

The image processing device of the embodiments may be realized by executing the image processing program with a computer having the aforementioned configuration.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment (s) of the present inventions has (have) been described in detail, it should be understood that the various changes, substitutions, and alterations could be made hereto without departing from the spirit and scope of the invention.

What is claimed is:

1. An image processing method for generating a combined image from first and second images of a plurality of images obtained through continuous shooting, the method comprising:
detecting a noise level in accordance with the first and second images;
calculating a shift amount for making the noise level small;
generating a transformed image by shifting coordinates of each pixel of the second image in accordance with the shift amount; and
combining the first image and the transformed image to generate the combined image.

2. The image processing method according to claim 1, further comprising:
detecting, as the noise level, a region in which a difference in a pixel value between the first and second images is larger than a threshold; and
calculating a shift amount for making the region small.

3. The image processing method according to claim 1, further comprising:
calculating, as the noise level, noisiness of the combined image obtained by combining the first and second images; and
calculating a shift amount for making the noisiness low. 30

4. The image processing method according to claim 1, further comprising:
detecting, as the noise level, a region in which a difference in a pixel value between the first and second images is larger than a threshold;
calculating, as the noise level, noisiness of the combined image obtained by combining the first and second images; and
calculating a shift amount for making the region small when the noisiness is lower than a specified threshold, and calculating a shift amount for making the noisiness small when the noisiness is higher than the threshold.

5. The image processing method according to claim 1, further comprising:
detecting, as the noise level, a region in which a difference in a pixel value between the first and second images is larger than a threshold;
calculating a first shift amount for making the region small;
calculating, as the noise level, noisiness of the combined image obtained by combining the first and second images;
calculating a second shift amount for making the noisiness small;
calculating a weight corresponding to the noisiness; and
calculating a shift amount in accordance with the first shift amount, the second shift amount and the weight.

6. The image processing method according to claim 1, further comprising
detecting a translation component of a positional displacement between the first and second images, wherein
the shift amount is calculated using the translation component as an initial value of the calculation.

7. The image processing method according to claim 1, wherein
the shift amount is calculated through a feedback operation using the noise level, and
the number of executions of the feedback operation is determined in accordance with an exposure time of the shooting.

8. The image processing method according to claim 1, wherein the shift amount is calculated within a range that is determined in accordance with a size of the first or second image and a possible maximum value of a rotation angle formed by a positional displacement between the first and second images.

9. The image processing method according to claim 1, wherein
the noise level is detected in a particular region within an image.

10. An image processing method for generating a combined image from first and second images of a plurality of images obtained through continuous shooting, the method comprising:
specifying a region in which a difference in a pixel value between the first and second images is larger than a threshold;
calculating a motion vector between the first and second images for a pixel within the specified region;
generating a transformed image by shifting coordinates of each pixel of the second image in accordance with the motion vector; and
combining the first image and the transformed image to generate the combined image.

11. An image processing device for generating a combined image from first and second images of a plurality of images obtained through continuous shooting, the image processing device comprising:
a noise level detection unit to detect a noise level in accordance with the first and second images;
a shift amount calculation unit to calculate a shift amount for making the noise level small;
an image shift unit to generate a transformed image by shifting coordinates of each pixel of the second image in accordance with the shift amount; and
an image combining unit to combine the first image and the transformed image to generate the combined image.

12. A non-transitory computer readable medium for storing a computer program which enables a computer to perform a method for generating a combined image from first and second images of a plurality of images obtained through continuous shooting, the method comprising:
detecting a noise level in accordance with the first and second images;
calculating a shift amount for making the noise level small;
generating a transformed image by shifting coordinates of each pixel of the second image in accordance with the shift amount; and
combining the first image and the transformed image to generate the combined image.
